(19) United States
(12) Patent Application Publication
(10) Pub. No.: US 2007/0192694 A1
(43) Pub. Date: Aug. 16, 2007

(54) Information display for disparate data sets

(75) Inventors: Jason M. Allor, Redmond, WA (US); Christian Madsen, Redmond, WA (US); Michael Svenholm Thomsen, Redmond, WA (US); Stephen P. Giff, Redmond, WA (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/352,659

(22) Filed: Feb. 13, 2006

(51) Int. Cl. G06F 17/00; G06F 9/00

(52) U.S. Cl. 715/713

(57) ABSTRACT

A computer-implemented user interface includes at least two hierarchically related element nodes. One node is a parent element node that is associated with a first set of property value components. Another node is a child element node that is associated with a second set of property value components. The first set of property value components is different than the second set. A property value component contained in at least one of the first and second sets is directly identified with a property identifier.

### BACKGROUND

It is sometimes desirable to implement a user interface that enables the user to review and/or enter properties for a group of elements. Typically, a grid control would be used to display the elements concisely and provide an efficient way for the user to enter property values as desired. FIG. 1 is an example of such a grid control.

The grid control illustrated in FIG. 1, which has been generally identified as item 100, includes a plurality of columns 102-110 and a plurality of rows 130-140. Row 130 contains a descriptor that identifies the nature of the information contained in each column. Each of rows 132-138 corresponds to an element. For each element, column 102 contains a name identifier. Similarly, columns 104-110 contain identifiers for type, length, modifier and inheritance. As is indicated in row 140, it may be possible for the user to add additional property values to grid control 100.

It should be noted that grid control 100 represents a very basic example. In some instances, the elements contained in the table of properties may be hierarchical in nature. In this case, the user interface may show a nested property list to enable the user to edit properties of child elements underneath top-level elements.

FIG. 2 is an illustration of a grid control 200 that includes a display of hierarchically organized elements. Grid control 200 is similar to grid control 100 but includes nested property lists 235 and 237 that are child elements underneath a top-level Name element 233. As is indicated by icon 240, it may be possible for a user to minimize and re-display the child element property lists as desired.

The appearance of grid control 200 is relatively neat at least because the child elements have the same structure as their associated parent element. In the illustrated example, all three contain a Name, a Type, a Length, a Modifier, and an Inheritance property. Because all of the elements throughout the hierarchy have the same set of properties, they all fit neatly into the grid control and share the same set of headers in row 230.

Certainly, scenarios are conceivable wherein child elements do not have the same property list as their parents. Further, other scenarios are conceivable wherein top-level elements X and Y have an identical structure, but the child elements of element X have a different set of properties, and the child elements of property Y have still another set of properties. In this situation, the elements no longer fit neatly into a grid control because the child elements do not share the same headers as the top-level elements.

One way to address the described challenge is to add a column for every property of every element throughout the hierarchy. This solution does not scale well when the elements can have any random set of properties, because the number of columns in the grid can quickly grow too large to be reasonably useful, and the grid can become very sparsely populated, very wide and difficult to read.

Another potential solution is to nest grid controls, with each nested grid control having its own set of headers and columns. This works reasonably well for relatively small data sets. However, the display can become unreadable very quickly because the headers at each level begin competing for the user's attention. When multiple nodes are extended, the grid becomes difficult to navigate and difficult to read.

Another challenge that arises in the context of property displays pertains to property lists that are dynamic and can be changed on a dependent basis. For example, scenarios are imaginable wherein an element's property list is dynamic and can change based on the value of another property or set of properties within the element or within a related element. For example, an element of type “car” may have the following properties: Make, Model, and Year. The system may be configured such that as soon as the user sets the values of these properties, additional, more specific properties show up for that element. For instance, if the user sets the Make to “Ford,” the Model to “Mustang,” and the Year to “1969,” two new properties may appear for the user to fill in, such as IsConvertible and IsRestored. However, if the user sets Make to “Honda,” Model to “Civic,” and Year to “2005,” then the IsCovertible and IsRestored properties do not appear, but instead another property called HasHybrideEngine appears instead.

The described type of dynamic user interface is difficult to model in a grid control. Even using nested grids as described above, the interface becomes quite noisy and busy, because entire columns of data will appear and disappear as the user adjusts the properties of the entity. Thus, the interface can be very difficult to read and confusing to use.

The discussion above is merely provided for general background information and is not intended for use as an aid in determining the scope of the claimed subject matter. Further, it should also be emphasized that the claimed subject matter is not limited to implementations that solve any or all of the disadvantages of any currently known systems noted in this section.

### SUMMARY

A computer-implemented user interface includes at least two hierarchically related element nodes. One node is a parent element node that is associated with a first set of property value components. Another node is a child element node that is associated with a second set of property value components. The first set of property value components is different than the second set. A property value component contained in at least one of the first and second sets is directly identified with a property identifier.

This Summary is provided to introduce, in a simplified form, a selection of concepts that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an example of a grid control.

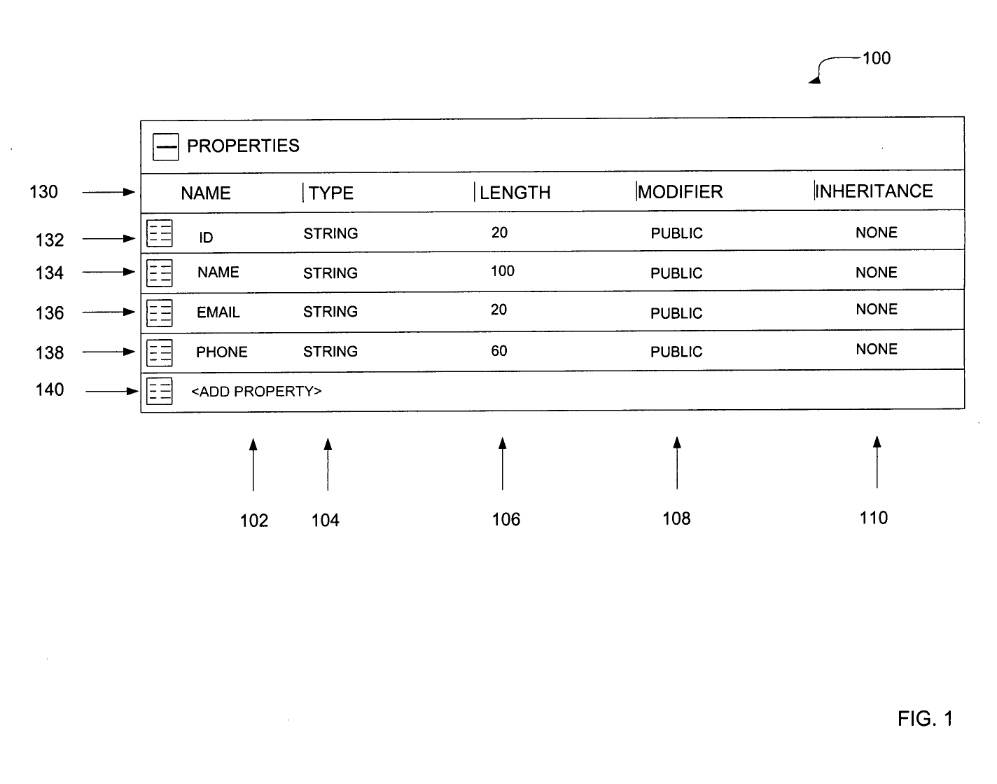

FIG. 2 is an example of a grid control that incorporates hierarchically organized elements.

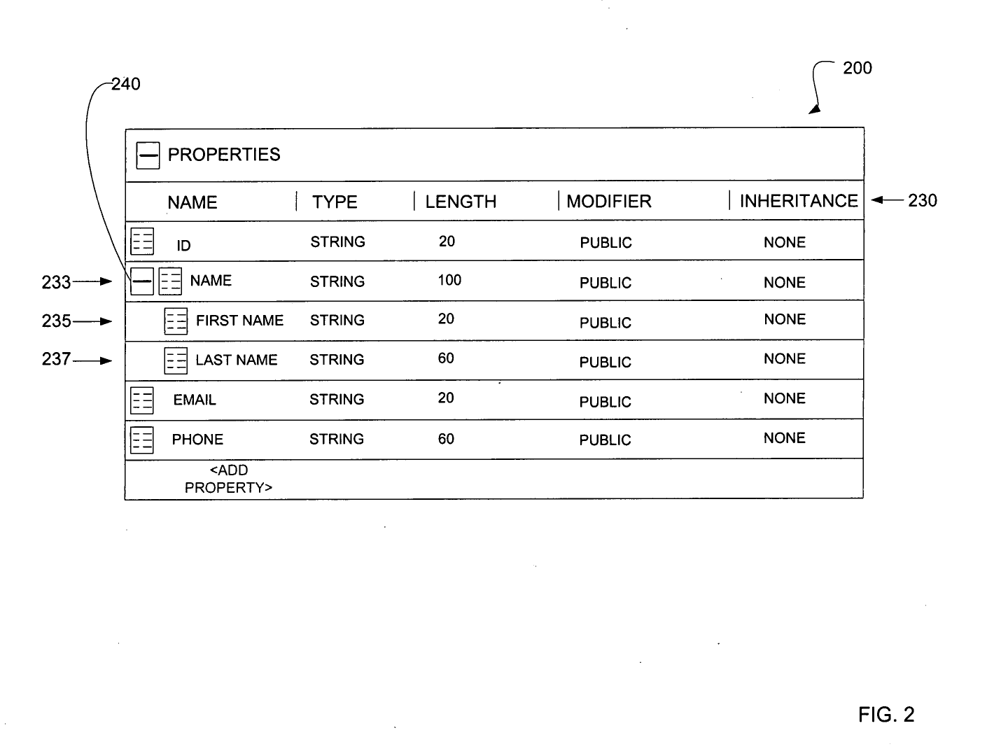

FIG. 3 is a block diagram of one computing environment in which some embodiments may be practiced.

FIG. 4 is an illustration of a dynamic property editor.

FIG. 5 is an illustration of a hierarchically organized grid display that incorporates dynamic property editor functionality.

FIG. 6 is an illustration demonstrating a re-configuration of the grid shown in FIG. 5.

FIG. 7 is a block flow chart demonstrating steps associated with re-configuring a display.

### DETAILED DESCRIPTION

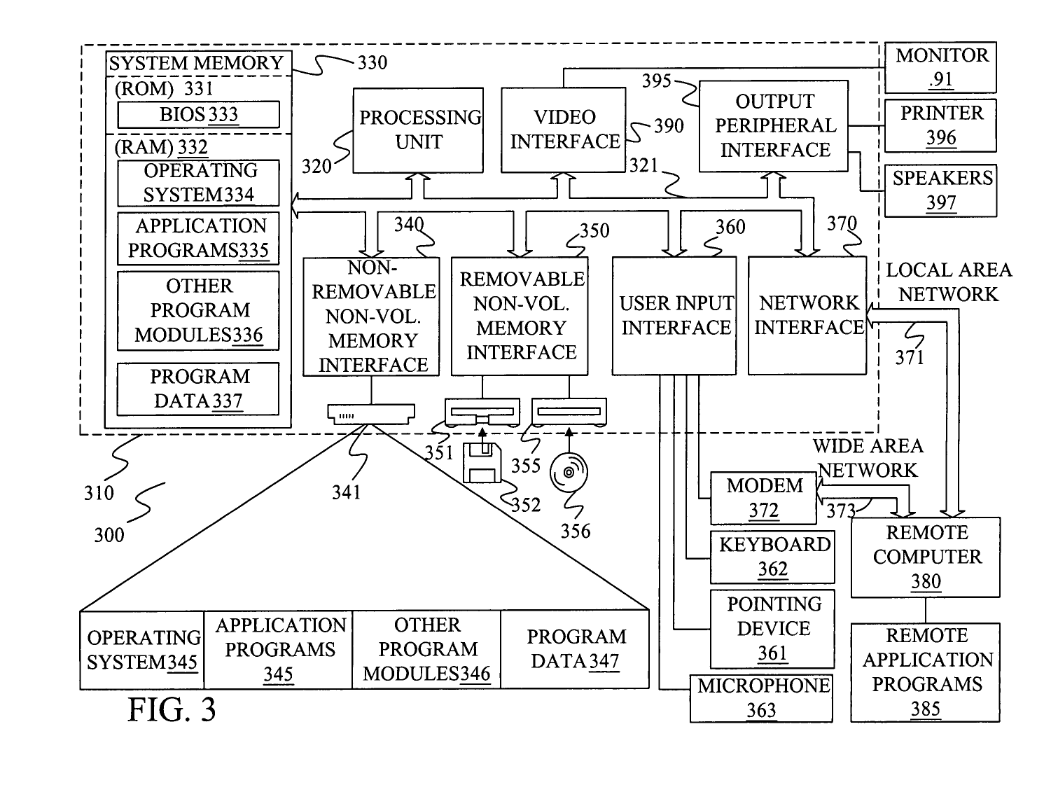

FIG. 3 illustrates an example of a suitable computing system environment 300 in which embodiments may be implemented. The computing system environment 300 is only one example of a suitable computing environment and is not intended to suggest any limitation as to the scope of use or functionality of the invention. Neither should the computing environment 300 be interpreted as having any dependency or requirement relating to any one or combination of components illustrated in the exemplary operating environment 300.

Embodiments are operational with numerous other general purpose or special purpose computing system environments or configurations. Examples of well-known computing systems, environments, and/or configurations that may be suitable for use with various embodiments include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

Embodiments may be described in the general context of computer-executable instructions, such as program modules, being executed by a computer. Generally, program modules include routines, programs, objects, components, data structures, etc. that perform particular tasks or implement particular abstract data types. Some embodiments are designed to be practiced in distributed computing environments where tasks are performed by remote processing devices that are linked through a communications network. In a distributed computing environment, program modules are located in both local and remote computer storage media including memory storage devices.

With reference to FIG. 3, an exemplary system for implementing some embodiments includes a general-purpose computing device in the form of a computer 310. Components of computer 310 may include, but are not limited to, a processing unit 320, a system memory 330, and a system bus 321 that couples various system components including the system memory to the processing unit 320. The system bus 321 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 310 typically includes a variety of computer readable media. Computer readable media can be any available media that can be accessed by computer 310 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 310. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 330 includes computer storage media in the form of volatile and/or nonvolatile memory such as read only memory (ROM) 331 and random access memory (RAM) 332. A basic input/output system 333 (BIOS), containing the basic routines that help to transfer information between elements within computer 310, such as during start-up, is typically stored in ROM 331. RAM 332 typically contains data and/or program modules that are immediately accessible to and/or presently being operated on by processing unit 320. By way of example, and not limitation, FIG. 3 illustrates operating system 334, application programs 335, other program modules 336, and program data 337.

The computer 310 may also include other removable/non-removable volatile/nonvolatile computer storage media. By way of example only, FIG. 3 illustrates a hard disk drive 341 that reads from or writes to non-removable, nonvolatile magnetic media, a magnetic disk drive 351 that reads from or writes to a removable, nonvolatile magnetic disk 352, and an optical disk drive 355 that reads from or writes to a removable, nonvolatile optical disk 356 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 341 is typically connected to the system bus 321 through a non-removable memory interface such as interface 340, and magnetic disk drive 351 and optical disk drive 355 are typically connected to the system bus 321 by a removable memory interface, such as interface 350.

The drives and their associated computer storage media discussed above and illustrated in FIG. 3, provide storage of computer readable instructions, data structures, program modules and other data for the computer 310. In FIG. 3, for example, hard disk drive 341 is illustrated as storing operating system 344, application programs 345, other program modules 346, and program data 347. Note that these components can either be the same as or different from operating system 334, application programs 335, other program modules 336, and program data 337. Operating system 344, application programs 345, other program modules 346, and program data 347 are given different numbers here to illustrate that, at a minimum, they are different copies.

A user may enter commands and information into the computer 310 through input devices such as a keyboard 362, a microphone 363, and a pointing device 361, such as a mouse, trackball or touch pad. Other input devices (not shown) may include a joystick, game pad, satellite dish, scanner, or the like. These and other input devices are often connected to the processing unit 320 through a user input interface 360 that is coupled to the system bus, but may be connected by other interface and bus structures, such as a parallel port, game port or a universal serial bus (USB). A monitor 391 or other type of display device is also connected to the system bus 321 via an interface, such as a video interface 390. In addition to the monitor, computers may also include other peripheral output devices such as speakers 397 and printer 396, which may be connected through an output peripheral interface 395.

The computer 310 is operated in a networked environment using logical connections to one or more remote computers, such as a remote computer 380. The remote computer 380 may be a personal computer, a hand-held device, a server, a router, a network PC, a peer device or other common network node, and typically includes many or all of the elements described above relative to the computer 310. The logical connections depicted in FIG. 3 include a local area network (LAN) 371 and a wide area network (WAN) 373, but may also include other networks. Such networking environments are commonplace in offices, enterprise-wide computer networks, intranets and the Internet.

When used in a LAN networking environment, the computer 310 is connected to the LAN 371 through a network interface or adapter 370. When used in a WAN networking environment, the computer 310 typically includes a modem 372 or other means for establishing communications over the WAN 373, such as the Internet. The modem 372, which may be internal or external, may be connected to the system bus 321 via the user input interface 360, or other appropriate mechanism. In a networked environment, program modules depicted relative to the computer 310, or portions thereof, may be stored in the remote memory storage device. By way of example, and not limitation, FIG. 3 illustrates remote application programs 385 as residing on remote computer 380. It will be appreciated that the network connections shown are exemplary and other means of establishing a communications link between the computers may be used.

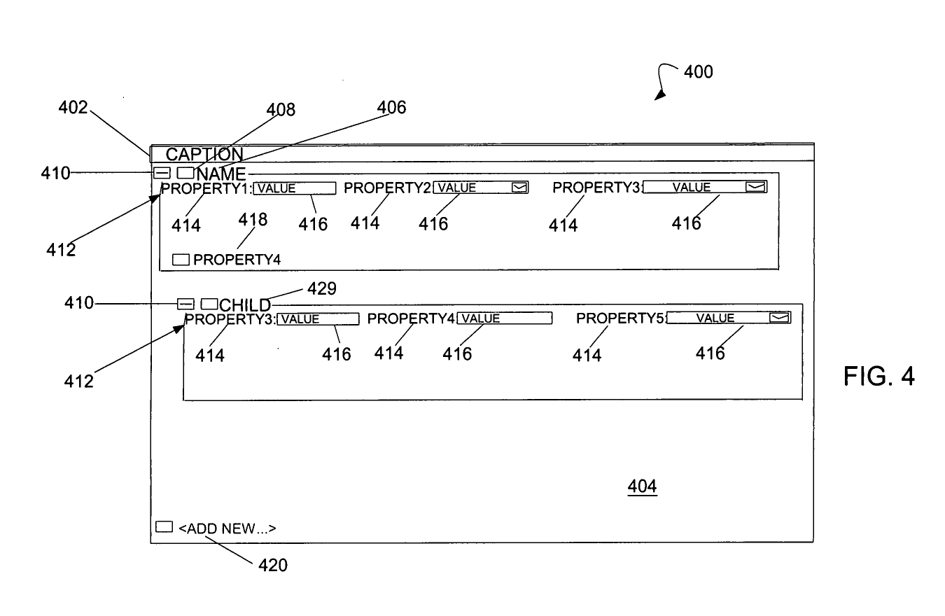

FIG. 4 is a diagrammatic illustration of a control 400, which can be more specifically referred to as a dynamic property editor. Control 400 is illustratively configured to display properties (e.g., editable properties) in a flexible, dynamic manner. Generally speaking, the properties are expressed as pairs that include a property name and a corresponding property value component (e.g., a box for entering data, a check box, a read-only box, etc.). This scheme of displaying with a property name eliminates any need for a column headers row. Control 400 is illustratively configured to automatically adjust the size and/or position of each individual property control, in particular as properties are added or removed from the panel at any time. An algorithm is illustratively applied in order to promote a neat appearance and efficient usage of space.

The dynamic property editor 400 is composed of an optional header 402 and a body 404. The header 402 illustratively provides context about the elements within the control 400. The body 404 contains a list of elements and their corresponding properties. In the case of FIG. 4, two elements are illustrated (the element identified as “CHILD” is hierarchically related to its parent element, which is on the top and slightly shifted to the left). As is illustrated, each element can be implemented as a collapsible group box containing relevant properties.

Each element illustratively includes several components. A first component is an element name 406 (identified as 429 in the child element). An optional icon 408 may be provided in order to establish a visual context as to the type of the element. Another icon identified as 410 supports the minimization or re-display of an element. Each element also includes a property list generally designated by arrow 412. For each property in the property list, a property name 414 and a property value 416 are provided.

As is indicated by the property value box associated with Property1 in FIG. 4, some values might be entered simply by direct text entry. Some property values might be selected automatically based on an environmental parameter, such as, but not limited to, a selection made by the user in a different property value box. For example, a particular value entered as Property2 might mandate what is selected as the value for Property1. As is illustrated by the property value boxes associated with Property2 and Property3, some values might be selectable by a user interaction with a drop-down selection box. As is indicated by Property4, which is generally designated as item 418, a property control could simply be a check box. Those skilled in the art will appreciate that any type of control can be provided for a given property.

In accordance with one embodiment, the property list 412 is dynamic in that it is configured to change based on the values set within the list of properties. For example, Property3 might disappear when a predetermined value is selected as Property2. In accordance with one embodiment, an algorithm is applied to account for the disappearance or addition of property information. For example, if a property is eliminated, the algorithm will illustratively change the display in order to encourage neatness and efficient use of space. This may involve changing the size of body 404. As is generally indicated by optional link 420, means can be provided to enable a user to add a new element to control 400.

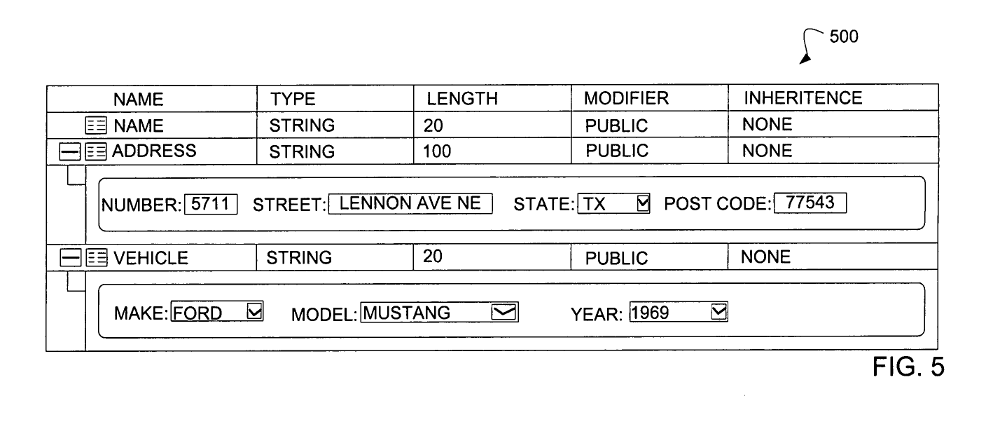

A dynamic property editor as described can be used as a standalone control or as a child control within another hierarchical control, such as a tree-grid control. FIG. 5 is a diagrammatic display of a display 500 that incorporates dynamic property editor functionality as described. Display 500 includes a property grid containing three elements, Name, Address and Vehicle. Address and Vehicle contain sub-properties, but these sub-properties are disparate and do not share the same types as their parents, or as one another. The dynamic property editor control is utilized to show the properties for each of the sub-elements.

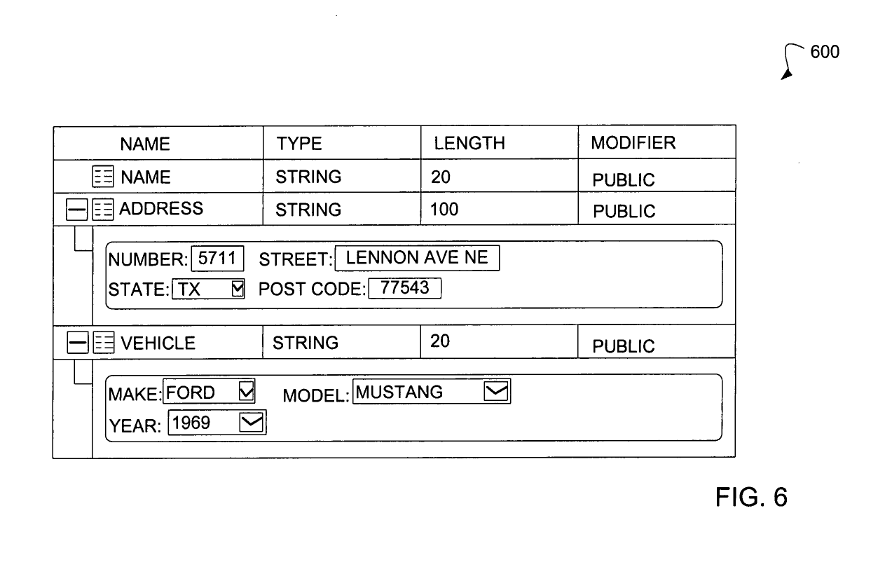

The dynamic property editor control is illustratively configured to apply an algorithm to automatically lay out the properties it contains according to the widths of the controls. For example, if the control shown in FIG. 5 is re-sized, each dynamic property editor control will illustratively be automatically re-configured to shuffle the locations of its contained properties. For example, FIG. 6 is an illustration of display 500 wherein the assumption is that the values listed as “None” have been eliminated and the overall display re-sized accordingly. In order to accommodate the re-sizing of the overall box, the properties within the dynamic property editor control have been re-organized into two rows instead of a single row.

An algorithm is illustratively applied to determine the optimal positioning of the sub-properties. Those skilled in the art will appreciate that the precise details of the algorithm will vary depending on the preferences associated with a given application. In general, the algorithm is configured to layout property controls such that a good balance is struck between widths of the controls and the total number of lines spanned by the controls. Optimally, each control should be wide enough to provide enough space to comfortably enter data into the control but short enough so that the controls do not span across more lines than necessary.

Thus, means are provided for neatly displaying properties in a hierarchical system wherein each node in the hierarchy can contain multiple properties and these properties can be of different types and appear or disappear depending on certain environmental dependencies. Child nodes in the hierarchy can contain different properties from their parents and their children. Siblings in the hierarchy can contain different sets of properties from one another. Properties of a node can come and go depending on the values of other values on that node.

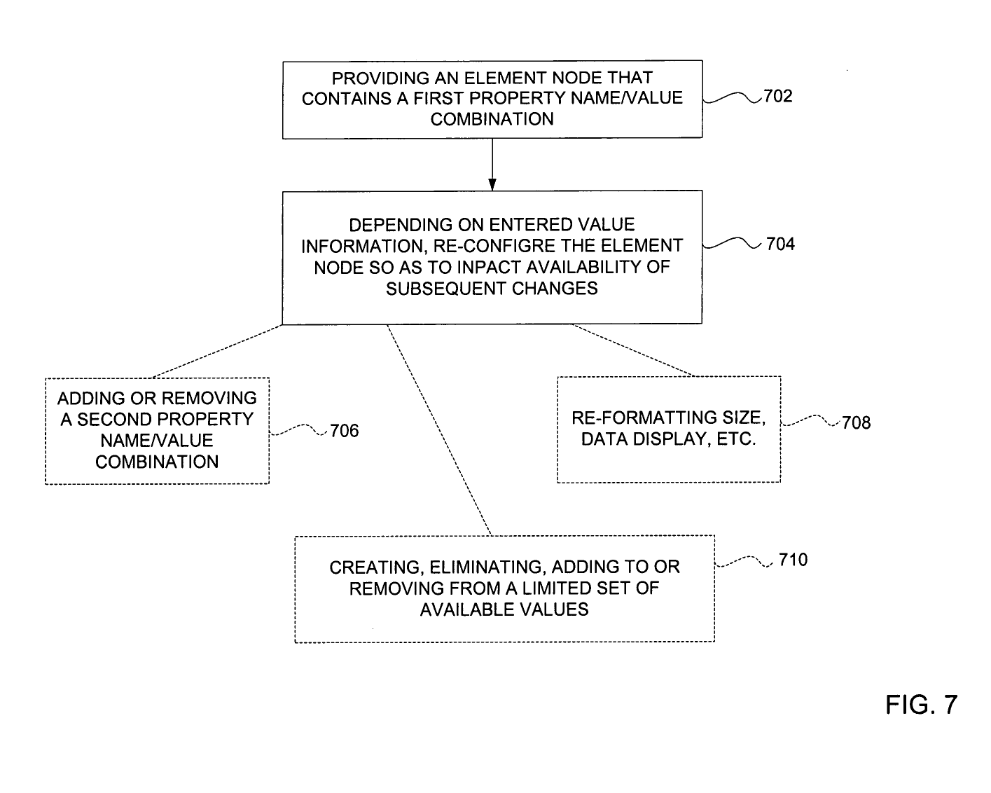

FIG. 7 is a block flow diagram illustrating steps associated with re-configuring an element node. In accordance with block 702, the method begins by providing an element node that contains a first property name that is positioned proximate to a first property value component. A property value component could be any type of control including, but not limited to, a text entry box, a text box that a user is not allowed to edit, a check box, a drop-down selection box, etc. In accordance with block 704, depending on a value associated with the first property value component, the configuration of the element node is altered so as to impact changes that can be made within the element node.

In accordance with block 706, altering the configuration of the element node comprises adding to the element node, or removing from the element node, a second property name that is positioned proximate to a second property value component. In accordance with block 708, altering the configuration of the element node comprises reformatting a visual characteristic of the element node. In accordance with block 710, altering the configuration of the element node comprises creating, eliminating, adding to, or removing from, a limited set of values that can be assigned to a property value component contained within the element node.

Those skilled in the art will appreciate that subtle alterations to the proposed display techniques can be made without departing from the scope of the present invention. As an example of one such change, it isn't required that a property name identifier appear directly to the left of its corresponding property value or property control box. For example, one could just as easily arrange for the name identifier to appear above or even to the right of value or control. Placement to the right might be desirable, for example, in the context of right-to-left reading languages such as Arabic. This is just one example of subtle modification to be considered within the scope of the present invention.

Those skilled in the art will also appreciate that the use herein of terms such as “property” and “property editor” are intended to be broadly construed. In general, the term “property” is intended to illustrate application of the described information display techniques. Without departing from the scope of the present invention, the same or similar techniques could just as easily be applied to support other uses of editing other configurations of data. Specifically, the same or similar techniques can be applied to support ways of configuring data for which it could not be said to include properties of a given node or object.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented user interface that includes at least two hierarchically related element nodes, wherein the user interface comprises:
a parent element node associated with a first set of property value components; and
a child element node associated with a second set of property value components, wherein the first set of property value components is different than the second set, and wherein a property value component contained in at least one of the first and second sets is directly identified with a property identifier.

2. The user interface of claim 1, wherein the property identifier is visually configured so as to trigger an inference as to a characteristic of only the directly identified property value component.

3. The user interface of claim 1, wherein the property value component directly identified with a property identifier is not identifiable through cross reference to an identifier placed in a corresponding column of a table.

4. The user interface of claim 1, wherein the user interface is configured such that a change in size of at least one of the parent and child element nodes triggers an automatic reformatting of how information is displayed within the element node.

5. The user interface of claim 1, wherein the user interface is configured such that, depending on user preference, the property value component that is directly identified with a property identifier can be removed from the interface and replaced with a visual indication that re-display is an alternative available to the user.

6. The user interface of claim 1, wherein at least one of the property value components contained in the first and second sets is configured to accept user input.

7. The user interface of claim 1, wherein at least one of the property value components contained in the first and second data sets is locked to a particular value depending on a user-selected value entered into another of the property value components contained in the first and second data sets.

8. The user interface of claim 1, wherein at least one of the property value components contained in the first and second data sets is a check box control.

9. A computer-implemented user interface that includes an element node configured to display property information that is relevant a particular element, wherein the element node comprises:
a first property value component that is positioned such that a corresponding characteristic is identifiable by an identifier that is aligned in a same column of a table; and
at least one additional property value component that is positioned such that no corresponding characteristic is identifiable by an identifier that is aligned in a same column of a table.

10. The user interface of claim 9, wherein the user interface is configured such that a change in the size of the element node triggers an automatic reformatting of how information is displayed within the element node.

11. The user interface of claim 9, wherein the user interface is configured such that, depending on user preference, said at least one additional property value component can be removed from the user interface and replaced with a visual indication that re-display is an alternative available to the user.

12. The user interface of claim 9, wherein said at least one additional property value component is identified by a property name positioned in close proximity thereto.

13. The user interface of claim 9, wherein at least one of the first and at least one additional property value components are configured to support an entry of data by a user.

14. A computer-implemented method for displaying property information through a user interface, the method comprising:
providing an element node that contains a first property name that is positioned proximate to a first property value component; and
depending on a value associated with the first property value component, altering the configuration of the element node so as to impact changes that can be made within the element node.

15. The method of claim 14, wherein providing an element node further comprises providing an element node that contains a first property name that is visually configured so as to trigger an inference as to a characteristic of the first property value component without triggering an inference as to a characteristic of a property value component outside the element node.

16. The method of claim 14, wherein altering the configuration of the element node comprises adding to the element node, or removing from the element node, a second property name that is positioned proximate to a second property value component.

17. The method of claim 16 further comprising, upon the addition or removal of the second property name and the second property value component, automatically reformatting at least one visual characteristic of the element node.

18. The method of claim 17, wherein automatically reformatting comprises reformatting a size characteristic of the element node.

19. The method of claim 17, wherein automatically reformatting comprises reformatting a manner in which information is displayed within the element node.

20. The method of claim 14, wherein altering the configuration of the element node comprises creating, eliminating, adding to, or removing from, a limited set of values that can be assigned to a property value component contained within the element node.
